(19) United States
(12) Patent Application Publication
(10) Pub. No.: US 2017/0214152 A1
(43) Pub. Date: Jul. 27, 2017

(54) Active Dual Antenna Arrangement

(71) Applicant: Kathrein Werke KG, Rosenheim (DE)

(72) Inventors: Maximilian Göttl, Rosenheim (DE); Roland Gabriel, Rosenheim (DE); Jürgen Rumold, Rosenheim (DE)

(21) Appl. No.: 15/394,300

(22) Filed: Dec. 29, 2016

(30) Foreign Application Priority Data
Jan. 27, 2016 (DE) 20 2016 100 381.4

(51) Int. Cl. H01Q 21/30; H04L 5/14; H01Q 5/30

(52) U.S. Cl. CPC H01Q 21/30; H01Q 5/30; H04L 5/14

(57) ABSTRACT

An active dual-band antenna arrangement (100), comprising a plurality of antenna elements (4), each with a transceiver connected thereto, wherein two antenna arrays (1, 2) are provided for the two frequency bands (B3, B7), wherein a first antenna array (1) processes the transmit band of the first frequency band (B3) and the receive frequency band of the second frequency band (B7), and wherein a second antenna array (2) processes the transmit frequency band of the second frequency band (B7) and the receive frequency band of the first frequency band (B3).

This application claims priority to Germany Utility Model No. 20 2016 100 381.4, filed Jan. 27, 2016.

### FIELD OF THE INVENTION

The invention relates to an active dual-band antenna arrangement, particularly a mobile radio antenna, according to the preamble of claim 1.

### BACKGROUND OF THE INVENTION

In mobile communications, new radio technologies are constantly being developed, so the technical limits, above all the capacity limits, of passive antenna systems are run up against more and more quickly. One solution is to equip an array of several radiating elements with separate transmission and reception amplifiers in order to thereby implement controllable antennas for beam control or even for MIMO operation. The use of a plurality of transmitter and receiver modules in MIMO operation is advantageous especially in situations in which no direct intervisibility exists between transmitter and receiver. For the past several years, the use of active antennas has been regarded as a solution for many of the problems in the area of capacity, transmission, increasing of data rates, etc., in mobile communications. Previously, active antenna arrays with a plurality of transceivers have not been able to gain wide-ranging acceptance for the following reasons.

The many active components pose a great challenge in terms of cost and reliability. Moreover, as a result of the high insertion losses of the duplex filters of up to 3 dB and the low efficiency of amplifiers in the low power range from 0.2 . . . 2 W, the overall efficiency of the active antenna arrays is very poor. Nor are any solutions currently known for multiband operation, so active antenna arrays have to be implemented separately for each transmit and receive band. This is also due to the frequent lack of a possibility for physically separating the radiators for the different bands due to space constraints. According to the invention, an elegant possibility is realized for enabling, with a filter solution, a dual utilization of the radiators used while simultaneously enabling, by means of the arrangement according to the invention, low demand to be placed on the filters used, particularly in terms of selection and/or stopband attenuation, which results, in turn, in low insertion loss.

As a result of users' high demand for data and bandwidth, an overcrowded spectrum is created in which the intermodulation products interfere with the receivers more strongly than before—that is, PIM occurs. Even the compact hardware of future mobile communication standards pose major problems for network operators due to limited linearity. This is also the case with already existing distributed antenna systems on the 2G/3G network. Passive intermodulation PIM occurs as a result of parasitic mixing of several frequency carriers through passive components within a transmission system, for example as a result of faulty connections, damage to an antenna, etc. Through the use of an ever-increasing number of frequency bands, more and more intermodulation products can occur that have a negative impact on the reception characteristics of the antennas and the base station. As a result of the increase in different frequency ranges and frequency bands in which antenna systems are currently being operated simultaneously, as already mentioned above, the danger of the occurrence of intermodulation products increases that fall not only in one's own frequency band to be transmitted but also possibly into other frequency bands that are to be operated over the same antenna system.

The higher generations of network technology, such as the MIMO (multiple-in-multiple-out) technology introduced for LTE, are now bringing about additional problems in terms of HF characteristics, since higher and higher data rates, etc., are required. In MIMO, several structurally identical antennas or antenna modules are used, and transmission occurs in the three dimensions of frequency, time, and space. For reception, the same number of receiving antennas or modules is preferably used. The receiver thus receives spatial information about the transmitted signal, thereby increasing the capacity of the system. Using this technique, the quality and data rates of a wireless connection can be increased significantly.

MIMO is already being used in the 4G standard and will be taken to the next level in the future, which is referred to as massive MIMO. In massive MIMO, research is being conducted even in the mm wavelength range, and TDD (Time Division Duplex) systems are preferred in the applications. Approaches also exist in which massive MIMO is used at conventional frequencies, that is, frequencies in the range of several GHz, with most of the spectrum being used with FDD (Frequency Division Duplex) systems.

The farther the developments forge ahead, the greater the focus on problems in the area of interference reduction, noise suppression, and short high-frequency optimization. In recent years, the potential of sectorization has been introduced and tested out. Horizontal sectorization achieves a good and stable improvement of data rates for all scenarios, such as urban, urban hinterland, and rural areas. Vertical sectorization works well in urban areas with tall buildings. The principle of sectorization is known and will not be discussed further here. Greater bandwidth, among other things, can be achieved using sectorization.

It is therefore an object of the present invention to provide an improved active dual-band antenna arrangement. An active antenna or antenna arrangement is understood as being an antenna in which one antenna is combined with at least two or more antenna boosters.

### SUMMARY OF THE INVENTION

What is proposed according to the invention is an active dual-band antenna arrangement comprising a plurality of antenna elements, each with a transceiver connected thereto, with two antenna arrays being provided for the two frequency bands, with a first antenna array processing the transmit band of the first frequency band and the receive frequency band of the second frequency band, and with a second antenna array processing the transmit frequency band of the second frequency band and the receive frequency band of the first frequency band.

In another embodiment, a provision is made that the antenna arrays are arranged vertically.

In another embodiment, a provision is made that the antenna array is an 8-column×6-row array.

In another embodiment, a provision is made that each of the transceivers comprises a duplex unit that is set up for the purpose of separating an input channel and an output channel from one another.

Preferably, each transceiver further comprises at least one filter and at least one amplifier. The filter is preferably an FBAR (Film Bulk Acoustic Resonator) or a BAW filter or SAW filter.

In another embodiment, a provision is made that several interconnected antenna elements are connected to a transceiver.

In another embodiment, a provision is made that the frequency bands are selected such that the frequency spacing between the respective transmission range of the first band and the reception range of the second band that are interconnected via a duplexer at the respective radiator is greater than 20 or 50 MHz, preferably 620 or 835 MHz.

In another embodiment, a provision is made that the antenna arrangement comprises a preprocessing unit that is set up for the purpose of carrying out an FDD massive MIMO operation.

Additional features and advantages of the invention follow from the description of exemplary embodiments of the invention below with reference to the figures of the drawing, which shows details of the invention, and from the claims. The individual features can each be implemented individually or in any combination in a variant of the invention.

### BRIEF DESCRIPTION OF THE DRAWINGS

Preferred embodiments of the invention are explained in further detail below with reference to the enclosed drawing.

FIG. 1 shows a view of an inventive antenna arrangement according to one embodiment of the present invention.

FIG. 2 shows a view of the subsystems shown in combination in FIG. 1.

### DETAILED DESCRIPTION

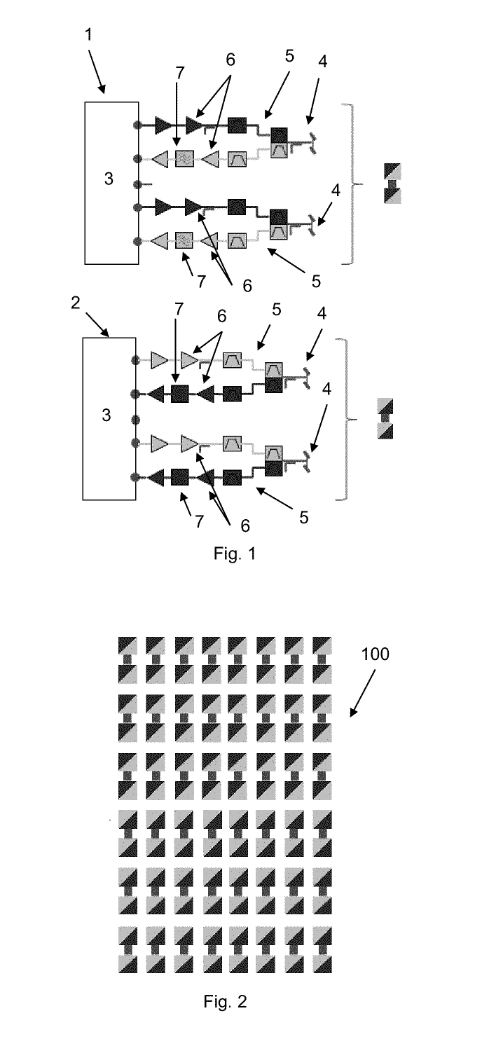

FIG. 1 shows an antenna arrangement according to the invention in which two antenna arrays 1 and 2, each of which comprises two interconnected antenna elements (4), according to one embodiment of the present invention. Two frequency bands, e.g., B3 and B7, are respectively disposed in a crosswise manner in one of the two subsystems 1 and 2 for a transmitter TX and the receiver RX, respectively, thereby forming an inverted array. In FIG. 1, a subsystem 1 supports the transmission in the B3 band and the reception in the B7 band, whereas the second subsystem 2 supports the transmission in the B7 band and the reception in the B3 band. Each subsystem comprises an SDR unit 3 for processing signals, etc. The separation into transmit channel and receive channel is performed by a duplex unit 5, to which additionally filters 7 and amplifiers 6 are connected in order to process the signals.

The described subsystems 1 and 2 are grouped together into arrays of subsystems and preferably combined vertically. This results in a compact system 100, as shown in FIG. 2. FIG. 1 shows an 8×6 array with 8 columns of antennas and 6 rows of antennas. The invention is not limited to the 8×6 array shown; rather, row/column combinations can be selected according to the desired application, e.g., 2×2, 3×3, 4×4 up to 8×8 arrays.

An array or antenna array is a matrix-like arrangement of individual antennas interconnected to form a system.

One advantage of the described architecture is that, due to the proposed crosswise arrangement of the possible transmitters and receivers, a 35-40 dB-wide insulation between RX (receiver) and TX (transmitter) in the same band, and PIM values of less than 150 dBc can be achieved, which is a prerequisite for FDD systems. As a result of the wide insulation, the spacing between RX and TX is increased from 20 or 50 MHz to 620 or 835 MHz in the example shown in FIG. 1. For the current exemplary embodiment, the frequency bands B3 and B7 are selected. Other frequency bands can also be selected, however, provided that they have a sufficient offset between RX and TX.

The proposed architecture results in a substantially smaller filter design, particularly in substantially less transmission loss. In addition, by virtue of the passive combining of two antenna arrays in the vertical direction, the number of power amplifiers can be reduced substantially in comparison to individually powered antennas, e.g., from 192 to 96 in the case of two arrays with 6×8 radiators and two-fold polarization, as shown in FIG. 1.

As mentioned previously, the filter design can be reduced by virtue of the proposed architecture; that is, large ceramic filters, etc., are no longer required, so favorable and efficient FBAR, BAW or SAW filters (film bulk acoustic resonators or miniature multiplexers) can be used, for example. In the present example, the attenuation is about 1.5 to 2 dB.

Furthermore, an internal preprocessing unit is preferably used if a great number of data streams are present, which is the case in an 8×6 array, for example. This preprocessing unit can reduce data streams and perform beamforming, and other functions can be implemented depending on the application; that is, the preprocessing unit can ensure FDD massive MIMO operation.

A plurality of antenna elements can also be connected to a transceiver, and even a plurality of interconnected antenna elements.

The proposed active dual-band antenna with the above-described inverted RX/TX architecture can be used in all areas of application, for example inside buildings, in cities, in more rural areas, or in the country, depending on the power at which it is to be operated.

1. An active dual-band antenna arrangement, comprising
a plurality of antenna elements, wherein either each of the antenna elements is connected to a transceiver or several interconnected antenna elements are connected to a transceiver,
first and second antenna arrays for a first and second frequency band, respectively,
wherein the first antenna array processes a transmit band of the first frequency band and a receive frequency band of the second frequency band, and
wherein the second antenna array processes a transmit frequency band of the second frequency band and a receive frequency band of the first frequency band.

2. The antenna arrangement as set forth in claim 1, wherein the first and second antenna arrays are arranged vertically.

3. The antenna arrangement as set forth in claim 1, wherein the first and second antenna arrays are arranged vertically and wherein each antenna array is an 8-column×6-row array.

4. The antenna arrangement as set forth in claim 1, wherein each of the transceivers of the antenna elements comprises a duplex unit that is set up for the purpose of separating an input channel and an output channel from one another.

5. The antenna arrangement as set forth in claim 2, wherein each transceiver further comprises at least one filter and at least one amplifier.

6. The antenna arrangement as set forth in claim 5, wherein the filter is an FBAR (Film Bulk Acoustic Resonator) filter or a BAW (Bulk Acoustic Wave) filter or a SAW (Surface Acoustic Wave) filter.

7-8. (canceled)

9. The antenna arrangement as set forth in claim 1, wherein the antenna arrangement comprises a preprocessing unit that is set up for the purpose of carrying out an FDD (Frequency-Division Duplexing) massive MIMO (Multiple-Input and Multiple-Output) operation.

10. The antenna arrangement as set forth in claim 2, wherein each of the transceivers comprises a duplex unit configured to separate an input channel and an output channel from one another.

11. The antenna arrangement as set forth in claim 3, wherein each of the transceivers comprises a duplex unit configured to separate an input channel and an output channel from one another.

12. The antenna arrangement as set forth in claim 5, wherein each transceiver further comprises at least one filter and at least one amplifier.

13. The antenna arrangement as set forth in claim 12, wherein the filter is an FBAR (Film Bulk Acoustic Resonator) filter or a BAW filter or a SAW filter.

14. The antenna arrangement as set forth in claim 11, wherein each transceiver further comprises at least one filter and at least one amplifier.

15. The antenna arrangement as set forth in claim 14, wherein the filter is an FBAR (Film Bulk Acoustic Resonator) filter or a BAW filter or a SAW filter.

16. The antenna arrangement as set forth in claim 2, wherein the antenna arrangement comprises a preprocessing unit that is set up for the purpose of carrying out an FDD massive MIMO operation.

17. The antenna arrangement as set forth in claim 3, wherein the antenna arrangement comprises a preprocessing unit that is set up for the purpose of carrying out an FDD massive MIMO operation.

18. The antenna arrangement as set forth in claim 4, wherein the antenna arrangement comprises a preprocessing unit that is set up for the purpose of carrying out an FDD massive MIMO operation.

19. The antenna arrangement as set forth in claim 10, wherein the antenna arrangement comprises a preprocessing unit that is set up for the purpose of carrying out an FDD massive MIMO operation.

20. The antenna arrangement as set forth in claim 11, wherein the antenna arrangement comprises a preprocessing unit that is set up for the purpose of carrying out an FDD massive MIMO operation.

21. The antenna arrangement as set forth in claim 12, wherein the antenna arrangement comprises a preprocessing unit that is set up for the purpose of carrying out an FDD massive MIMO operation.

22. The antenna arrangement as set forth in claim 13, wherein the antenna arrangement comprises a preprocessing unit that is set up for the purpose of carrying out an FDD massive MIMO operation.
